(19) United States
(12) Patent Application Publication
(10) Pub. No.: US 2004/0218080 A1
(43) Pub. Date: Nov. 4, 2004

(54) Digital camera with preview alternatives

(76) Inventors: Donald J. Stavely, Windsor, CO (US); Kenneth J. Hall, Windsor, CO (US); Amy E. Battles, Windsor, CO (US); Sarah J. Barrios, Fort Collins, CO (US); Robert E. Sobol, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/428,721

(22) Filed: May 2, 2003

(51) Int. Cl. H04N 5/222

(52) U.S. Cl. 348/333.11

(57) ABSTRACT

A preview mode for a digital camera, and associated method, that displays more than one alternative interpretation of a photographic image that is to be recorded. A user selects the best of the alternatives before the photographic image is taken. Thus, the photographic image is more optimally exposed and processed.

### TECHNICAL FIELD

The present invention relates generally to digital cameras, and more specifically, to a digital camera having preview alternatives and associated method.

### BACKGROUND

In digital photography, a sensor captures a fairly narrow dynamic range of the image scene. Exposure must be very accurate in order not to clip highlights or have noisy shadows. Also, the “photofinishing” step is done immediately inside the camera. The color balance and tone reproduction decisions are made in firmware and hardware before it is stored to the cameras memory card. Image data is truncated and compressed to a final image format, such as 8 bit-per color JPEG.

In this process, the camera must guess how a user would like to interpret the scene. If the guess is wrong, both the exposure and the photofinishing process will be wrong. For example, the user might intend that a picture taken at sunset be warm and shadowy, or he/she may intend it to be corrected back to balanced daylight. Editing the image later cannot correct the image, because of the short exposure, the reddish color balance, and the data compression all limit the data that was captured and saved.

What is needed is a way to verify the user's intent for how the image will be rendered before the exposure is taken. Accordingly, it is an objective of the present invention to provide for an improved digital camera having preview alternatives.

### SUMMARY OF THE INVENTION

To accomplish the above and other objectives, the present invention provides for a preview mode for digital cameras, and associated method, that displays more than one alternative interpretation of a photographic image that is to be recorded. A user selects the best of the alternatives before the photographic image is taken. Thus, the photographic image is more optimally exposed and processed.

The alternatives are generated through an intelligent algorithm implemented in a processor of the camera that analyzes the scene content. This algorithm may be an extension of current camera exposure, color balance, and tone reproduction algorithms. These algorithms typically select the best among a set of rendering alternatives, based on the preview image data. Instead of choosing only the top candidate for the exposure, the camera presents a predetermined number of candidates, such as the top two or three candidates, for example.

An exemplary digital cameras comprises imaging optics, an image sensor for receiving images transmitted by the imaging optics, a display device, and a processor that implements a preview algorithm that displays a plurality of alternative images to a user that each having different exposure settings, one of which is selected as the image to be recorded.

An exemplary method comprises the following steps. A digital camera is provided having a display device, and a processor that implements a preview algorithm that generates and displays a predetermined number of alternative images to a user, each having different exposure settings. An image that is to be recorded in the display device is framed by the user. When the shutter button is partially depressed, or if a preview button on the camera is depressed, the camera displays a predetermined number of alternative versions of the framed image to a user, that each have a different exposure setting. One of the alternative versions of the framed image is selected as the image to be recorded. The selected image is then exposed and processed to record it.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIGS. 1a and 1b are front and back views, respectively, that illustrate an exemplary embodiment of a digital camera in accordance with the principles of the present invention having a preview mode that permits preview alternatives; and

FIG. 2 is a flow diagram illustrating and exemplary method in accordance with the principles of the present invention.

### DETAILED DESCRIPTION

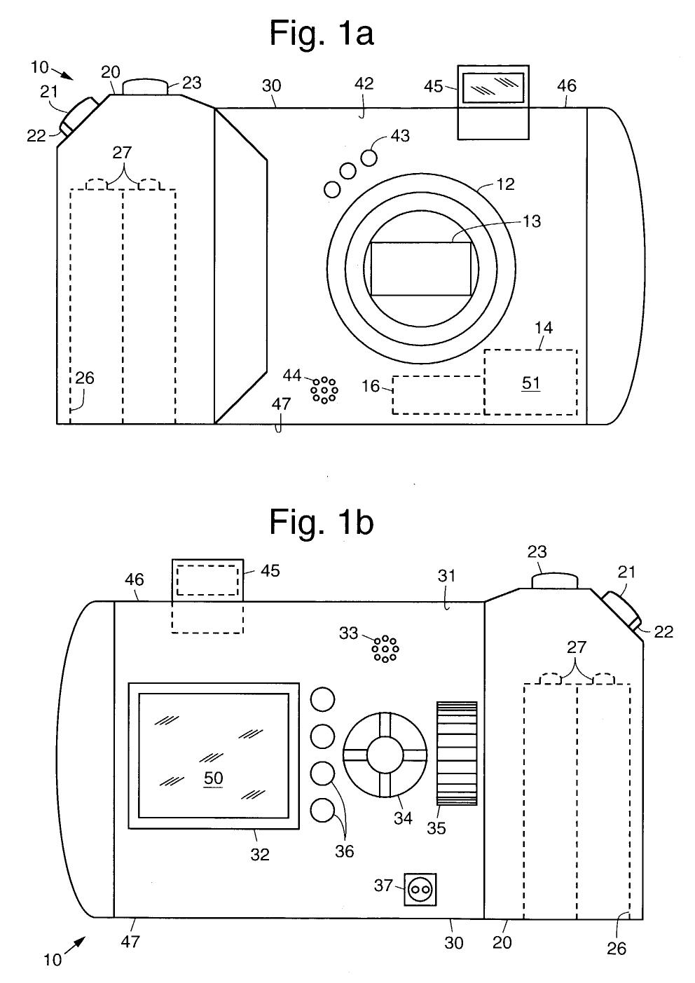

Referring to the drawing figures, FIGS. 1a and 1b show front and back views, respectively, that illustrate an exemplary embodiment of a digital camera 10 in accordance with the principles of the present invention. The exemplary digital camera 10 comprises an preview mode 50 in accordance with the principles of the present invention that permits preview alternatives.

The exemplary digital camera 10 comprises a handgrip section 20 and a body section 30. The handgrip section 20 includes a power button 21 having a lock latch 22, a shutter button 23 (or record button 23), and a battery compartment 26 for housing batteries 27. As is shown in FIG. 1a, a metering element 43 and microphone 44 are disposed on a front surface 42 of the digital camera 10. A pop-up flash 45 is located adjacent the top surface 46 of the digital camera 10.

As is shown in FIG. 1a, the digital camera 10 also comprises a lens 12, or imaging optics 12, and an image sensor 13 for receiving images transmitted by the imaging optics 12. A processor 14 (or microprocessors 14) is coupled to the image sensor 13 (and other control and input/output components). A memory device 16 is coupled to the image sensor 13 and processor 14 that is used to store images recorded by the digital camera 10.

As is shown in FIG. 1b, a rear surface 31 of the exemplary digital camera 10 includes a display device 32, such as a color liquid crystal display (LCD), a color microdisplay 32 or organic light emitting diode (OLED) display 32, for example, a rear microphone 33, a joystick pad 34, a zoom control dial 35, a plurality of buttons 36, including a preview mode button 36, for setting functions of the camera 10, and an output port 37 for downloading images to an external display device or computer, for example.

The preview mode 50 (generally designated) embodied in the digital camera 10 displays on the display device 32 more than one alternative interpretation of an image before it is recorded. For example, several alternative interpretations may be sequentially presented to the user for consideration. The user selects the best of the alternatives before the photograph is taken. Thus the picture is more optimally exposed and processed.

The alternatives are generated through an intelligent preview algorithm 51 embodied in the processor 14 that analyzes image scene content. This algorithm 51 may be an extension of camera exposure, color balance, and tone reproduction algorithms currently used in digital cameras. These algorithms typically select the best among a set of rendering alternatives, based on the preview image data. Instead of choosing only the top candidate for the exposure the camera presents or displays a predetermined number (a plurality) of candidates, such as the top two or three candidates, for example, to the user in the display device 32.

Currently available liquid crystal display (LCD) technology is generally inadequate for judging all but the most extreme differences in presentation. The present invention employs microdisplay or OLED technology in order to make the present invention much more practical and useful.

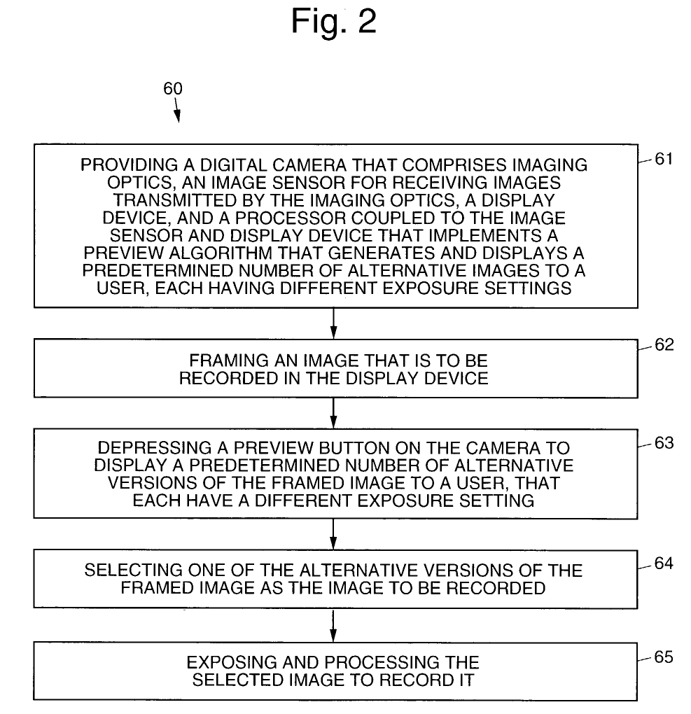

FIG. 2 is a flow diagram illustrating and exemplary method 60 in accordance with the principles of the present invention. The exemplary method 60 comprises the following steps.

A digital camera is provided 61 that comprises imaging optics 12, an image sensor 13 for receiving images transmitted by the imaging optics, a display device 32, and a processor 14 coupled to the image sensor 13 and display device 32 that implements a preview algorithm 51 that generates and displays a predetermined number of alternative images to a user, each having different exposure settings. An image that is to be recorded is framed 62 in the display device 32. A preview button 36 on the camera is depressed 63 to display a predetermined number of alternative versions of the framed image to a user, that each have a different exposure setting. The preview alternatives may automatically displayed in response to the shutter button being depressed part-way, to the “S1” position. One of the alternative versions of the framed image is selected 64 as the image to be recorded. The selected image is exposed and processed 65 to record it.

Thus, an improved digital camera having a preview mode that permits preview alternatives and related method have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A digital camera comprising:
imaging optics;
an image sensor for receiving images transmitted by the imaging optics;
a display device; and
a processor coupled to the image sensor and display device that implements a preview algorithm that displays a predetermined number of alternative images to a user, each having different exposure settings, one of which is selected as the image to be recorded.

2. The digital camera recited in claim 1 wherein the display device comprises a color microdisplay.

3. The digital camera recited in claim 1 wherein the display device comprises a organic light emitting diode (OLED) display.

4. A method comprising the steps of:
providing a digital camera comprising imaging optics, an image sensor for receiving images transmitted by the imaging optics, a display device, and a processor coupled to the image sensor and display device that implements a preview algorithm that generates and displays a predetermined number of alternative images to a user, each having different exposure settings;
framing an image that is to be recorded in the display device;
depressing a preview button on the camera to display a predetermined number of alternative versions of the framed image to a user, that each have a different exposure setting;
selecting one of the alternative versions of the framed image as the image to be recorded; and
exposing and processing the selected image to record it.

5. The method recited in claim 4 wherein the predetermined number of alternative versions of the framed image are sequentially presented to the user.
